(19) United States
(12) Patent Application Publication
(10) Pub. No.: US 2010/0114897 A1
(43) Pub. Date: May 6, 2010

(54) INDEXING AND SEARCHING A NETWORK OF MULTI-FACETED ENTITY DATA

(76) Inventors: Ricardo Polo-Malouvier, Levallois-Perret (FR); Bruno Dumant, Verneuil sur Seine (FR); Bogdan Marinoiu, Bures sur Yvette (FR)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/253,518

(22) Filed: Oct. 17, 2008

(51) Int. Cl. G06F 17/30

(52) U.S. Cl. 707/741; 707/E17.014; 707/E17.136

(57) ABSTRACT

Some aspects include determination of a first set of attribute-value pairs associated with an entity, the first set of attribute-value pairs comprising a plurality of attributes and first values, and respective ones of the first values corresponding to each of the plurality of attributes, determination of a second set of attribute-value pairs associated with the entity, the second set of attribute-value pairs comprising the plurality of attributes and second values, and respective ones of the second values corresponding to each of the plurality of attributes, and generation of index entries, each of the index entries indicating one of the first set or the second set of attribute-value pairs, an attribute of the indicated set of attribute-value pairs, a value of the attribute of the indicated set of attribute-value pairs, and the entity.

In some aspects, a first set of attribute-value pairs associated with an entity is determined, the first set of attribute-value pairs comprising a plurality of attributes and first values, and respective ones of the first values corresponding to each of the plurality of attributes, a second set of attribute-value pairs associated with the entity is determined, the second set of attribute-value pairs comprising the plurality of attributes and second values, and respective ones of the second values corresponding to each of the plurality of attributes, one of the plurality of attributes is determined to be mono-valued, a priority of the first set of attribute-value pairs is determined to be higher than a priority of the second set of attribute-value pairs for the determined attribute, and a first value associated with the determined attribute from the first set of attribute-value pairs is added to a profile of the entity, while a second value associated with the determined attribute from the second set of attribute-value pairs is not added to the profile of the entity.

### BACKGROUND

Modern organizations receive, generate and store vast quantities of electronic information. Much of this information is associated in some manner with one or more people. For example, home address information may be stored by a human resources system, tax-related information may be stored by an accounting system, and project-related information may be stored by a resource planning system.

Conventional systems do not provide efficient mechanisms to identify people in an organization based on information stored as described above. Additionally, conventional systems do not provide suitable aggregation of such information for presentation to a requester, particularly in a case that two data sources provide different types of personal information and/or conflicting personal information (e.g., different home addresses). Even if the above-described identification and aggregation could be achieved by conventional systems, new security systems would be needed to ensure that sensitive personal information is not obtained without proper authorization.

Systems are desired for identifying entities based on data from disparate sources and for aggregating information associated with the entities. Compatible mechanisms to limit unauthorized access to specified information are also desired.

### BRIEF DESCRIPTION OF THE DRAWINGS

FIG. 1 is a block diagram of a system according to some embodiments.

FIG. 2 comprises tabular representations of portions of multi-faceted entity data according to some embodiments.

FIG. 3 is a flow diagram of a process according to some embodiments.

FIG. 4 comprises a tabular representation of a portion of an index according to some embodiments.

FIGS. 5A and 5B comprise a flow diagram of a process according to some embodiments.

FIG. 6 is a view of a search interface according to some embodiments.

FIG. 7 is a view of a search interface according to some embodiments.

FIG. 8 is a view of a search interface according to some embodiments.

### DETAILED DESCRIPTION

The following description is provided to enable any person in the art to make and use the described embodiments and sets forth the best mode contemplated for doing so. Various modifications will remain readily apparent to those in the art.

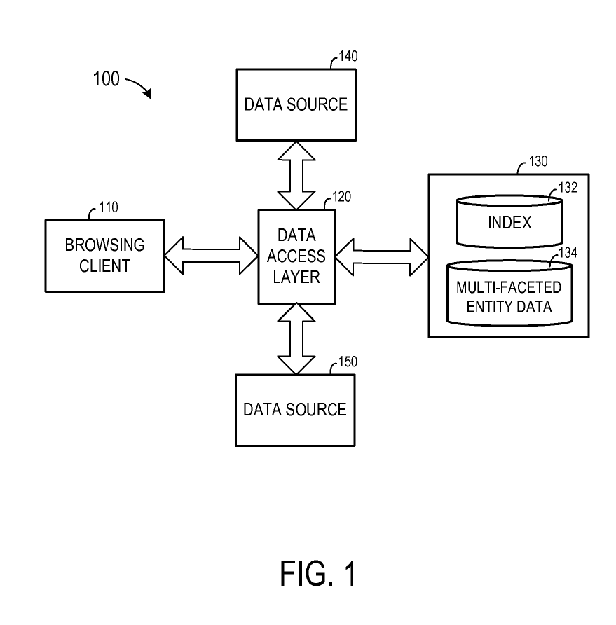

FIG. 1 is a block diagram illustrating architecture 100 according to some embodiments. Browsing client 110 may communicate with data access layer 120 to submit queries and/or to receive entity profiles. Browsing client 110 may comprise any suitable device, such as a desktop computer, a laptop computer, a personal digital assistant, a tablet PC, and a smartphone. Browsing client 110 may execute program code of a rich client application, an applet in a Web browser, or any other application to perform the processes attributed thereto herein.

Data access layer 120 may provide security functions (i.e., authentication, etc.) to manage access to data stored in database system 130, and may provide encapsulation of the data. Data access layer 120 may implement an application programming interface (API) that is called by browsing client 110 to query database system 130.

Data access layer 120 may receive a search query from browsing client 110 and modify the search query as will be described below. In some embodiments, data access layer 120 aggregates attribute values associated with an entity in database system 130 to generate a result profile as will also be described below. Data access layer 120 may therefore comprise executable program code according to some embodiments.

Data access layer 120 may also comprise a load module to implement an API used by data sources 140 and 150. Data sources 140 and 150 may call this API to provide data to database system 130, and data access layer 120 may store and index the data in system 130 as described herein.

Database system 130 includes index 132, multi-faceted entity data 134, and any other modules and/or database management systems necessary for operation. Elements of database system 130, and of architecture 100 generally, may be located remote from one another.

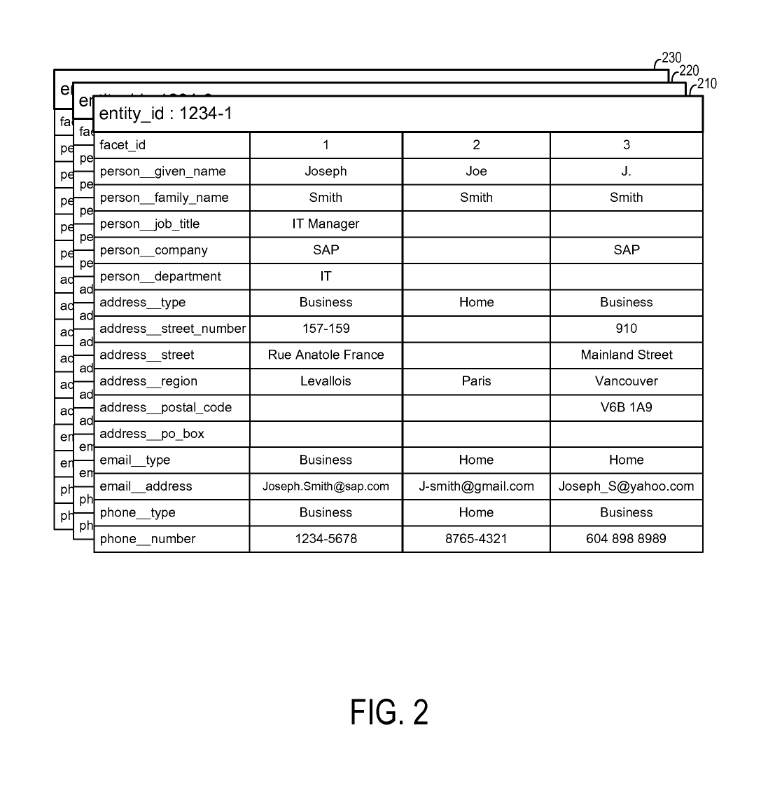

Multi-faceted entity data 134 may comprise any types and number of data structures storing data associated with entities. The data may comprise attribute values, and is termed “multi-faceted” because a single entity may be associated with two or more values for a same attribute. FIG. 2 shows tabular representations of tables 210 through 230 storing multi-faceted entity data according to some embodiments.

Each of tables 210 through 230 is associated with a different entity identified by a unique entity_id. The entities discussed herein are people, but embodiments are not limited thereto. In this regard, the leftmost column of each of tables 210 through 230 includes attribute identifiers representing individual attributes that may be associated with a person-type entity.

Each attribute may be associated with an identifier of an attribute group to which the attribute belongs, if any. For example, the attributes person_given_name and person_family_name may both belong to the “name” attribute group, and the attributes address_street_address and address_postal_code may both belong to the “address” attribute group. An attribute may also be associated with a Boolean value (e.g., is_mono_valued) indicating whether the attribute may be logically associated with more than one value. In another example, the attribute person_given_name may be indicated as mono-valued (i.e., a person has only one given name), while an attribute email_address may be indicated as multi-valued (i.e., a person may have more than one email address).

An attribute group may also be associated with a Boolean value (i.e., is_mono_valued) indicating whether the attribute group may be logically associated with more than one value. Using the foregoing examples, the “name” attribute group may be indicated as mono-valued, and the “address” attribute group may be indicated as multi-valued. An attribute associated with an attribute group may also be associated with a Boolean value (e.g., is_a_discriminant) indicating whether the attribute is a discriminant, the meaning of which will be evident from the following discussion. The group identifiers and the Boolean values associated with attributes and/or attribute groups may be stored in database system 130 or any other suitable location.

Table 210 associates entity “1234-1” with three facet_ids. Each facet_id represents a set of attribute-value pairs. For example, the set of attribute-value pairs associated with facet_id “1” includes the attributes represented in the leftmost column of table 210 and respective ones of the values within the column of facet_id “1”. Similarly, the set of attribute-value pairs associated with facet_id “3” includes the attributes of the leftmost column of table 210 and respective ones of the values within the column of facet_id “3”.

As shown, the set of attribute-value pairs associated with one facet_id may be inconsistent with the set of attribute-value pairs associated with another facet_id. Also, some attribute-value pairs may include no value. According to some embodiments, each facet_id may represent values received from one information source, and a single information source may be associated with more than one facet_id. Embodiments are contemplated for use with any suitable internal and/or external information sources, and in conjunction with any organizations. In this regard, embodiments are not limited to architecture 100.

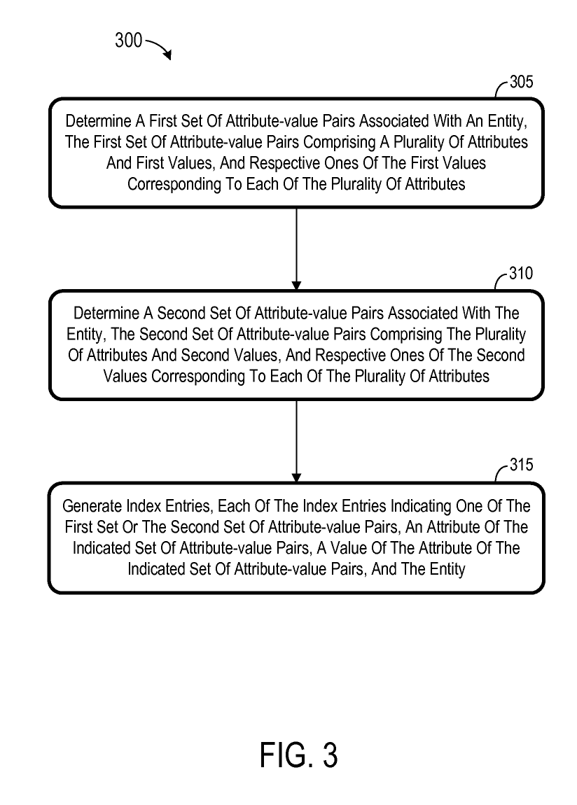

FIG. 3 is a flow diagram of process 300 according to some embodiments. Process 300 may be executed by hardware and embodied in program code stored on a tangible computer-readable medium. Process 300 may be performed by data access layer 120 and/or database system 130 of architecture 100, but embodiments are not limited thereto. Process 300 may be executed in response to a command to generate index entries based on multi-faceted entity data 134.

Initially, a first set of attribute-value pairs associated with an entity are determined. The first set of attribute-value pairs includes two or more attributes and first values, with respective ones of the first values corresponding to each of the two or more attributes. Table 210, as described above, provides three examples (i.e., facets “1”, “2” and “3”) of a set of attribute-value pairs associated with an entity (i.e., entity “1234-1”), with respective ones of the first values corresponding to each of the two or more attributes. Accordingly, and for example, facet “1” may be determined at 305.

Next, at 310, a second set of attribute-value pairs associated with the entity is determined. The second set of attribute-value pairs includes the two or more attributes mentioned with respect to 305 and also includes second values, with respective ones of the second values corresponding to each of the two or more attributes. Continuing with the present example, facet “2” of table 210 may be determined at 310.

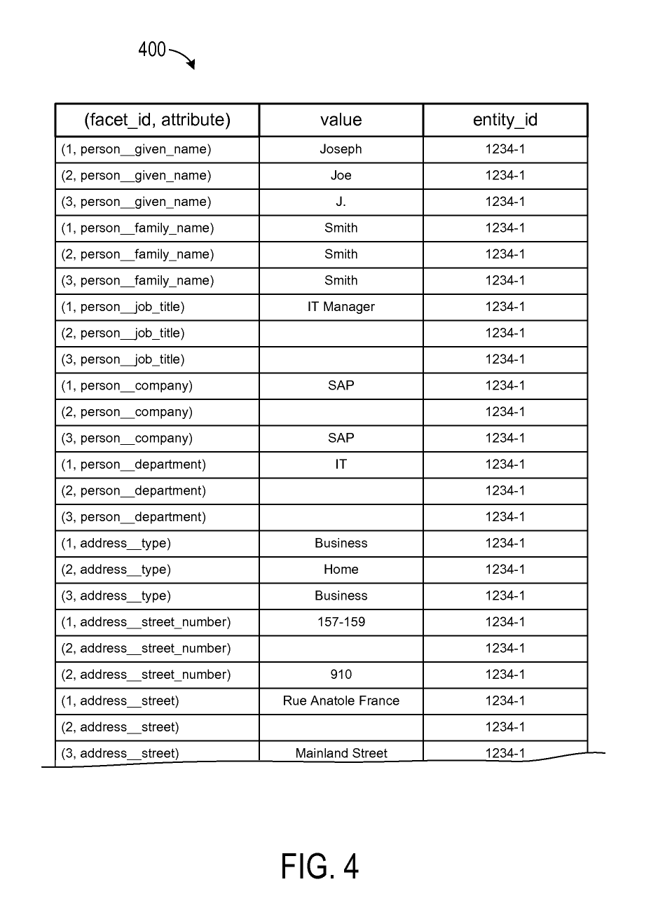

Index entries are generated at 315. Each of the index entries indicates one of the first set or the second set of attribute-value pairs, an attribute of the indicated set of attribute-value pairs, a value of the attribute of the indicated set of attribute-value pairs, and the entity. FIG. 4 is a tabular representation of index entries 400 generated according to some embodiments of 315. Index entries 400 may be stored in index 132 of database system 130.

As shown, each entry of index entries 400 indicates one of the first set or the second set of attribute-value pairs (i.e., facet_ids “1” or “2”), an attribute of the indicated set of attribute-value pairs (i.e., attribute), a value of the attribute of the indicated set of attribute-value pairs (i.e., value), and the entity (i.e., entity_id “1234-1”). Index entries 400 may be structured in any suitable manner, not limited to that shown in FIG. 4.

Although process 300 specifies only two sets of attribute-value pairs, index entries may be generated at 315 for more than two sets of attribute-value pairs as shown in FIG. 4. Generally, process 300 may be performed for all sets of attribute-value pairs associated with an entity in data 134, and may be similarly repeated for each entity that is associated with sets of attribute-value pairs within data 134. Index entries 400 are therefore not limited to one entity and/or to the attribute-value pairs associated with one entity as shown in FIG. 4.

According to some embodiments, all index entries of index 132 associated with a given entity are deleted once a new set of attribute-value pairs associated with the entity is stored in data 134. Process 300 is then executed for all sets of attribute-value pairs associated with the entity to generate new index entries for the entity in index 132.

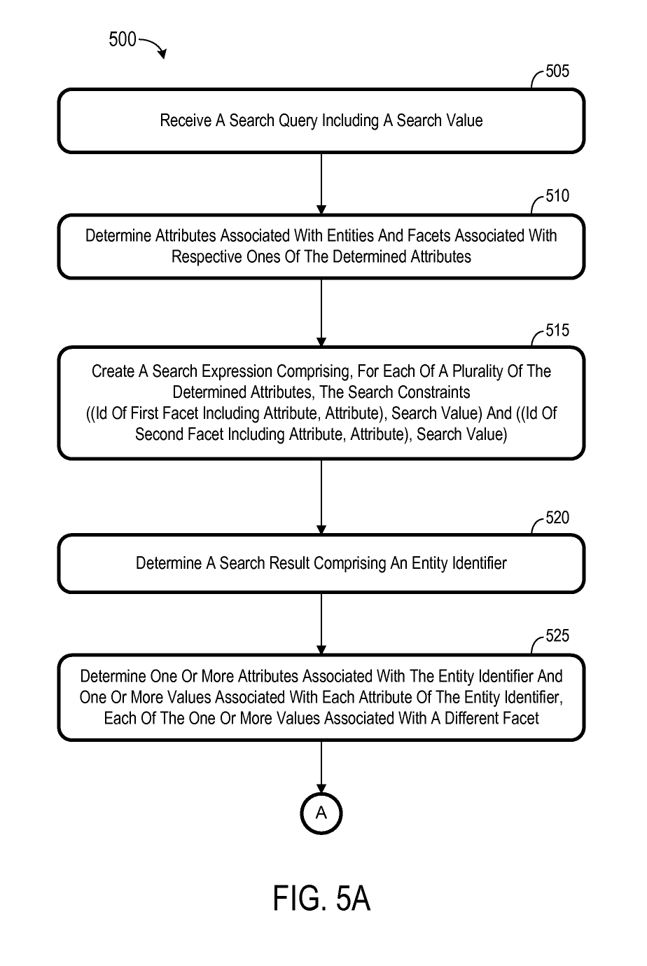

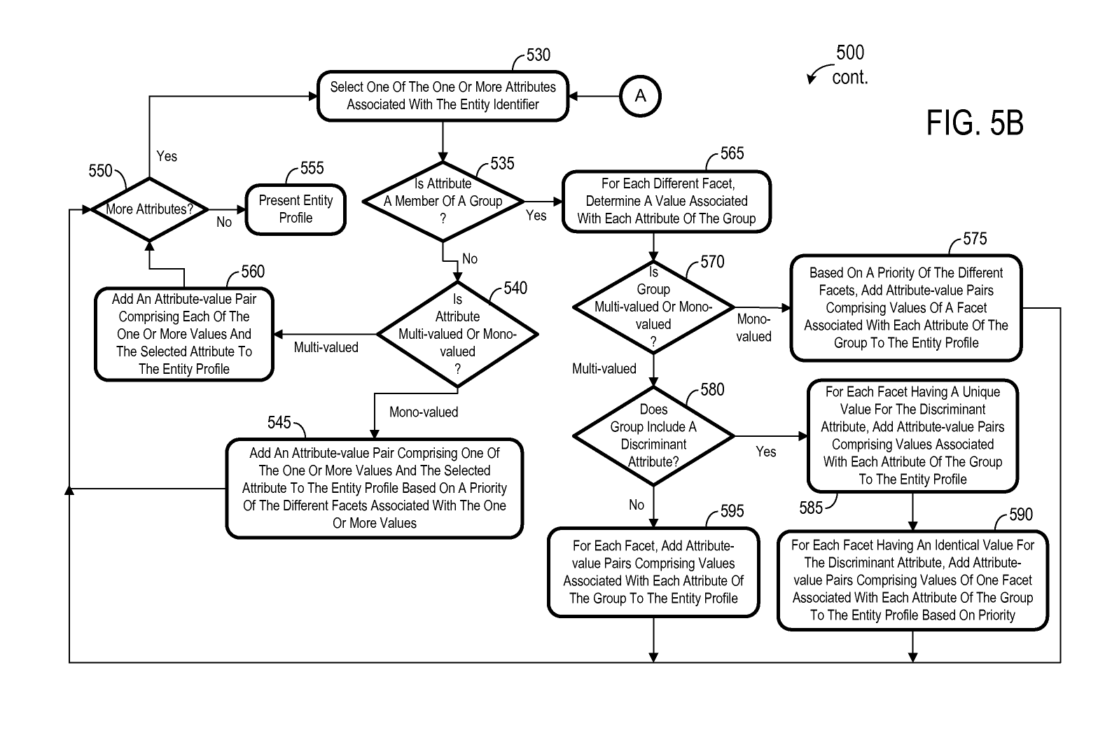

FIGS. 5A and 5B illustrate process 500 according to some embodiments. Process 500 may be embodied in program code of data access layer 120 and performed by execution thereof.

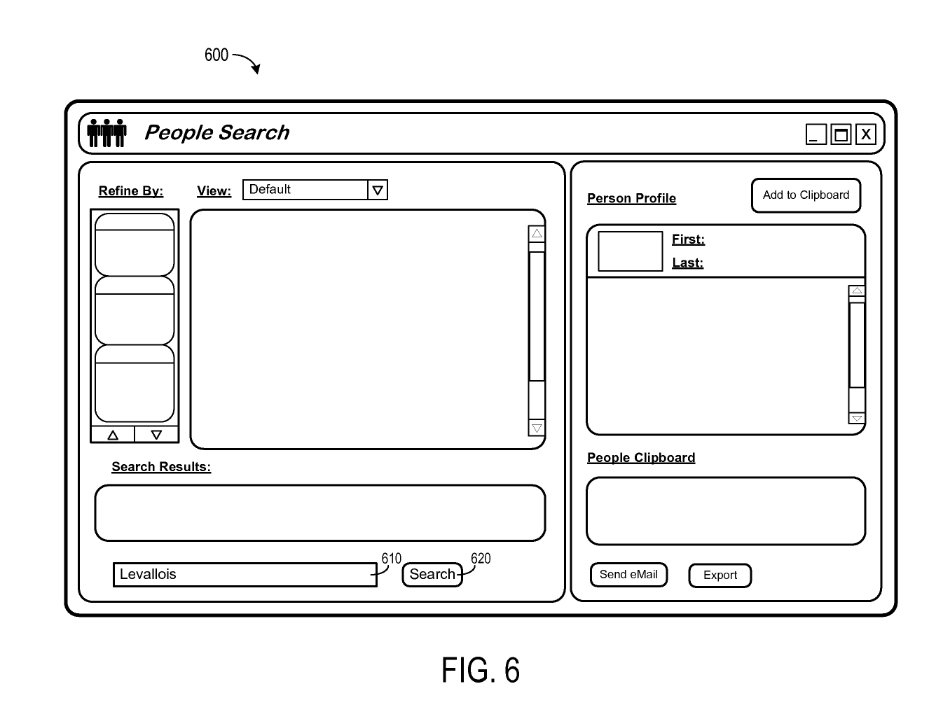

A search query including a search value is received at 505. FIG. 6 illustrates user interface 600 which may be presented by browsing client 110 according to some embodiments of process 500. A user may be required to enter credentials (e.g., username and password) into a login screen in order to access user interface 600 and to thereby establish an identity (i.e., and a corresponding security profile) of the user. Interface 600 includes search box 610 in which a user may enter a search term. The entered search term may be received by data access layer 120 upon selection of Search button 620.

After receipt of the search term, attributes associated with entities are determined at 510. Also determined at 510 are sets of attribute-value pairs (i.e., facets) which are associated with respective ones of the determined attributes. For example, multi-faceted entity data 134 may store data structures specifying each attribute that is associated with an entity in data 134. The attributes may therefore be determined at 510 from these data structures. These data structures may also specify the Boolean values and group identifiers which may be associated with each attribute as described above.

Multi-faceted entity data 134 may also store data indicating which particular attributes are associated with each facet. In this regard, although facets “1”, “2” and “3” of the FIG. 2 example are each associated with the same set of attributes (although not necessarily with the same attribute values), some facets might be associated with slightly or completely different sets of attributes. Therefore, 510 comprises determining all attributes associated with entities, and, for each particular attribute, a list of all facets associated therewith.

A search expression is created at 515 based on the received search value and on the attributes and facets determined at 510. For each of a plurality of the determined attributes, the search expression includes the search constraints ((facet_id of first facet including the attribute, attribute), search value) and ((facet_id of second facet including the attribute, attribute), search value). For example, using the search value of FIG. 6 and the facets shown in FIG. 2, the search constraints may comprise ((1, person_given_name), Levallois) and ((2, person_given_name), Levallois). Of course, the search expression may also contain the search constraint ((3, person_given_name), Levallois), as well as a similar three search constraints for each other attribute of facets “1”, “2” and “3”. Each search constraint is OR'ed with each other search constraint to create the search expression.

In contrast, conventional systems create search expressions that do not distinguish between facets. A search expression created by a conventional system would include a single search constraint per attribute, such as (person_given_name, Levallois) OR (person_family_name, Levallois) OR (person_job_title, Levallois) OR . . . .

A search expression according to some embodiments, and an index which supports such search expressions, may provide efficient facet-based filtering. For example, a security profile of the user may indicate that the user is not allowed to access data from the data source associated with facet “2”. Accordingly, the search expression created at 515 may omit any constraints associated with facet “2” (e.g., ((2, person_given_name), Levallois)), even if facet “2” is associated with one or more of the plurality of determined attributes.

In some embodiments, additional constraints may be added to the search expression at 515 based on a user's security profile. For example, a user may be authorized only to view profiles of members of an IT department. The search expression therefore includes a search constraint specifying the search-limiting attribute person_department and the search-limiting value “IT”. Assuming that the attribute person_department is determined at 510 to be associated with only facets “1”, “2” and “3”, the partial expression [((1, person_department), IT) OR ((2, person_department), IT) OR ((3, person_department), IT)] is AND'ed with a search expression created as described above.

A security profile may also or alternatively indicate that a user is not allowed to search on a particular attribute, such as “salary”. The search expression created at 515 therefore omits any search constraints specifying the attribute “salary”, even if this attribute and its associated facets are determined at 510. Any combination of the above-mentioned security-related considerations may be employed during creation of a search expression at 515.

More than one search value may be received at 505 in some embodiments. An individual search expression may be created at 515 for each received search value as described above. The individual search expressions are then AND'ed together to create a search expression for use at 520.

The search expression is applied against a search index (e.g., index entries 400) and a search result is received at 520. The search result may include one or more entity identifiers, however, for clarity, the remainder of process 500 will be described with respect to only one received entity identifier. The described process may be repeated for each received entity identifier.

All attributes and values associated with the entity identifier are determined at 525. The attributes and values may be determined from index 132 (e.g., index entries 400 specify the attributes and facet-specific values thereof) and/or from multi-faceted entity data 134. Some attributes may be associated with more than one value, with each of the one or more values being associated with a different facet as illustrated in FIG. 2.

Some embodiments allow a user to directly query data access layer 120 for a user profile using an entity identifier (i.e., without performing an initial search). In response to such a query, data access layer 120 may determine attributes and values associated with the entity identifier at 525 and proceed as described below.

One of the attributes determined at 525 is selected at 530. At 535, it is determined whether the attribute is a member of a group. As mentioned above, data 134 may include metadata specifying whether an attribute is a member of a group. In the present example, it will be assumed that the selected attribute is “person_birth_date” and is not a member of an attribute group. Flow therefore continues to 540.

At 540, it is determined whether the attribute is multi-valued or mono-valued. This determination is also based on the aforementioned metadata. Continuing with the present example, flow proceeds from 540 to 545 because the attribute “person_birth_date” is mono-valued (i.e., a person has only one birthdate).

An attribute-value pair comprising the selected attribute and one value is added to an entity profile at 545. If only one value was determined to be associated with the attribute at 525, the attribute-value pair simply comprises the selected attribute and the one value. However, if more that one value was determined to be associated with the attribute at 525, then one of the one or more values is selected for inclusion in the attribute-value pair based on a priority.

For example, one facet (i.e., facet “A”) associated with the entity identifier may include an attribute-value pair (person_birth_date, Oct. 10, 1968) and another facet (i.e., facet “B”) associated with the entity identifier may include an attribute-value pair (person_birth_date, Oct. 1, 1968). The metadata of multi-faceted entity data 134 may indicate a relative priority of each facet associated with each attribute. In other words, the attribute “person_birth_date” may be associated with the facet priority (in order of descending priority) “B”, “A”, and “D”, wherein facets “B”, “A”, and “D” each include the attribute “person_birth_date”. In view of this priority, the value “Oct. 1, 1968” is included in the attribute-value pair added to the entity profile at 545.

Next, at 550, it is determined whether any attributes for which values were determined at 525 remain to be added to the entity profile. If not, the entity profile is presented to a user at 555. Presentation of the entity profile will be discussed below after the description of the remaining elements of process 500. Flow returns to 530 if the determination at 550 is affirmative.

A next one of the attributes determined at 525 is selected at 530. Again, it is determined at 535 whether the attribute is a member of a group. It will now be assumed that the selected attribute is “person_project” and is not a member of an attribute group. Flow therefore continues to 540.

At 540, it is determined that the selected “person_project” attribute is multi-valued (i.e., a person may be associated with more than one project). Flow therefore proceeds from 540 to 560. At 560, an attribute-value pair comprising the selected attribute and each of one or more associated values is added to the entity profile. Therefore, regardless of how many values were determined to be associated with the attribute at 525, an attribute-value pair is added to the entity profile which includes the attribute and all of the associated values.

For example, facet “A” associated with the entity identifier may include an attribute-value pair (person_project, Saturn) and facet “B” associated with the entity identifier may include an attribute-value pair (person_project, Mars). Accordingly, an attribute-value pair (person_project, Saturn, Mars) is added to the entity profile at 560. Flow may then proceed through 550 to 530 to select another attribute as described above.

Next, it will be assumed that the attribute “person_family_name” is selected at 530. It is then determined at 535 that this attribute is part of the attribute group “name”. Accordingly, at 565, a value associated with each attribute of the attribute group is determined for each different facet associated with the attribute group. That is, all attributes of the attribute group are determined (e.g., “person_given_name” and “person_family_name”) and values of each attribute are determined for each associated facet. With reference to FIG. 2, the values “Joseph”, “Joe” and “J.” are determined for the attribute “person_given_name” and the values “Smith”, “Smith” and “Smith” are determined for the attribute “person_family_name”.

It is then determined, at 570, whether the attribute group is mono-valued or multi-valued. Such a determination may be based on the aforementioned metadata of data 134. The attribute group of the present example is mono-valued, therefore flow proceeds to 575.

Attribute-value pairs comprising each attribute of the group and one value are added to an entity profile at 575. If only one value was determined to be associated with each of the group attributes at 565, each of the attribute-value pairs would simply comprises a group attribute and the one value associated therewith. However, if more than one value was determined to be associated with any group attribute at 565, then one of the more than one values is selected for inclusion in the associated attribute-value pair based on a priority at 575.

For example, the attribute-value pair (person_family_name, Smith) is added to the entity profile because only one value (i.e., “Smith”) was determined to be associated with the group attribute “person_family_name” at 565. However, three different values (i.e., “Joseph”, “Joe” and “J.”) are associated with the group attribute “person_given_name”. The metadata of multi-faceted entity data 134 may indicate a relative priority of each facet associated with each attribute group. For example, the attribute group “name” may be associated with the facet priority (in order of descending priority) “1”, “3”, and “2”. In view of this priority, the value “Joseph” of facet “1” is included in an attribute-value pair (person_given_name, Joseph) that is added to the entity profile at 575. Flow then proceeds to 550 and on to 530 if attributes remain which have not been assigned to an attribute-value pair of the entity profile.

Assuming that the attribute “address_street_number” is selected at 530, it is then determined at 535 that the selected attribute is part of the attribute group “address”. Therefore, at 565, a value associated with each attribute of the attribute group (e.g., “address_type”, “address_street_number”, “address_street”, “address_region”, “address_postal_code”, and “address_po_box”) is determined for each different facet associated with the attribute group.

Next, at 570, it is determined whether the attribute group is mono-valued or multi-valued. Flow proceeds from 570 to 580 in the present example because the attribute group “address” is multi-valued. At 580, it is determined whether the group includes a discriminant attribute. According to the present example, the group attribute “address_type” is defined to be a discriminant attribute. Generally, an entity profile should not contain attribute-value pairs for two different groups having identically-valued discriminant attributes. With reference to the present example, the entity profile should not include a first set of attribute-value pairs for “address” group attributes and a second set of attribute-value pairs for “address” group attributes where the value associated with the “address_type” attribute is identical in both sets of attribute-value pairs.

Flow continues to 585 if the group includes a discriminant attribute. For each facet having a unique value for the discriminant attribute, attribute-value pairs comprising each group attribute and an associated value are added to the entity profile at 585. Turning to table 210 of FIG. 2, facet “2” associates a unique value “Home” with the “address_type” attribute. Accordingly, the attribute-value pairs (address_type, Home) and (address_region, Paris) are added to the entity profile.

At 590, for each facet having a same value for the discriminant attribute, attribute-value pairs comprising each group attribute and an associated value are added to the entity profile based on priority. For example, facets “1” and “3” both associate the value “Business” with the “address_type” discriminant attribute. The attribute group “address” may be associated with the facet priority (in order of descending priority) “3”, “1”, and “2”. Accordingly, attribute-value pairs (address_type, Home), (address_street_number, 910), (address_street, Mainland Street), (address_region, Vancouver), and (address_postal_code, V6B 1A9) are added to the entity profile at 590. Flow then proceeds to 550 and continues as described above.

Flow reaches 595 in a case that a selected attribute is a member of a multi-valued group and does not include a discriminant attribute. At 595, attribute value pairs associated with each attribute of the attribute group and including all associated values are added to the entity profile.

As mentioned above, the entity profile is presented to the user at 555 if no more attributes for which values were determined at 525 remain to be added to the entity profile. Presentation of the entity profile at 555 may comprise transmission of all attribute-value pairs of the entity profile to browsing client 110.

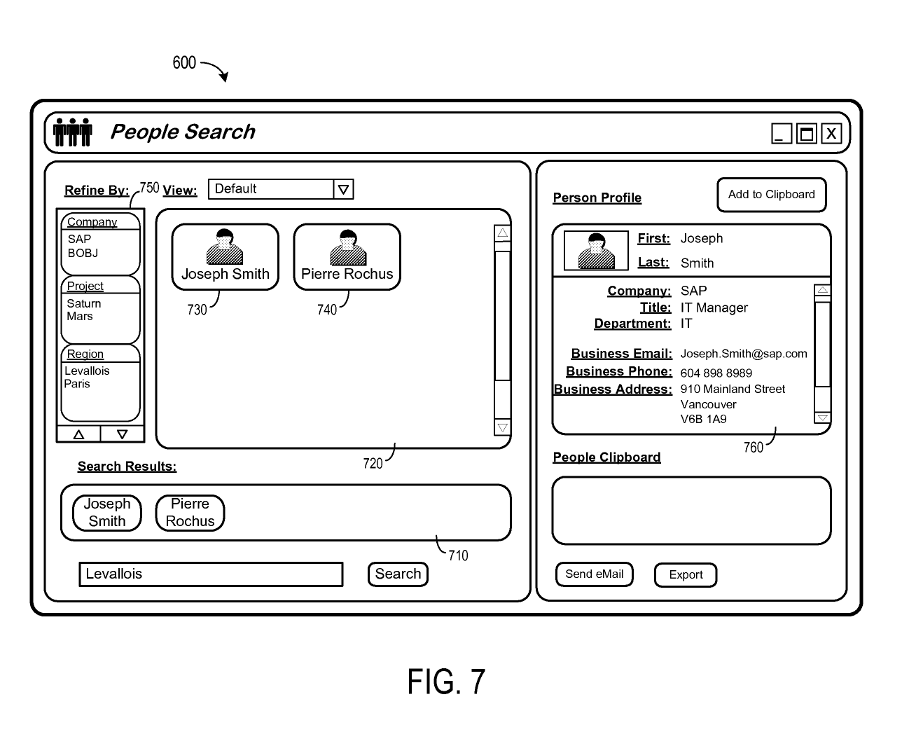

User interface 600 of FIG. 7 presents an entity profile according to some embodiments. More specifically, results window 710 and browsing window 720 show icons related to entities identified according to process 500. In this regard, although the above description relates to the determination of an entity profile associated with one entity, FIG. 7 assumes that the search result determined at 520 includes two entity identifiers.

Browsing window 720 may provide several types of views according to some embodiments. For example, browsing window 720 may provide a graph illustrating relations between the entities associated with icons 730 and 740. Navigation window 750 lists attributes and values associated with these entities, and may change dynamically based on the attributes and values associated with whatever entities happen to be currently displayed in browsing window 720. Selection of one or more attribute values of navigation window 750 may filter the results displayed in browsing window 720 based on the selected attribute values.

Profile window 760 presents selected attribute-value pairs of an entity profile associated with an entity (i.e., entity_id 1234-1). The entity profile may have been created as described with respect to process 500. The particular selected attribute-value pairs may be determined based on global or user-specific defaults. Selection of icon 740 in browsing window 720 may cause profile window 760 to display an entity profile of the associated entity.

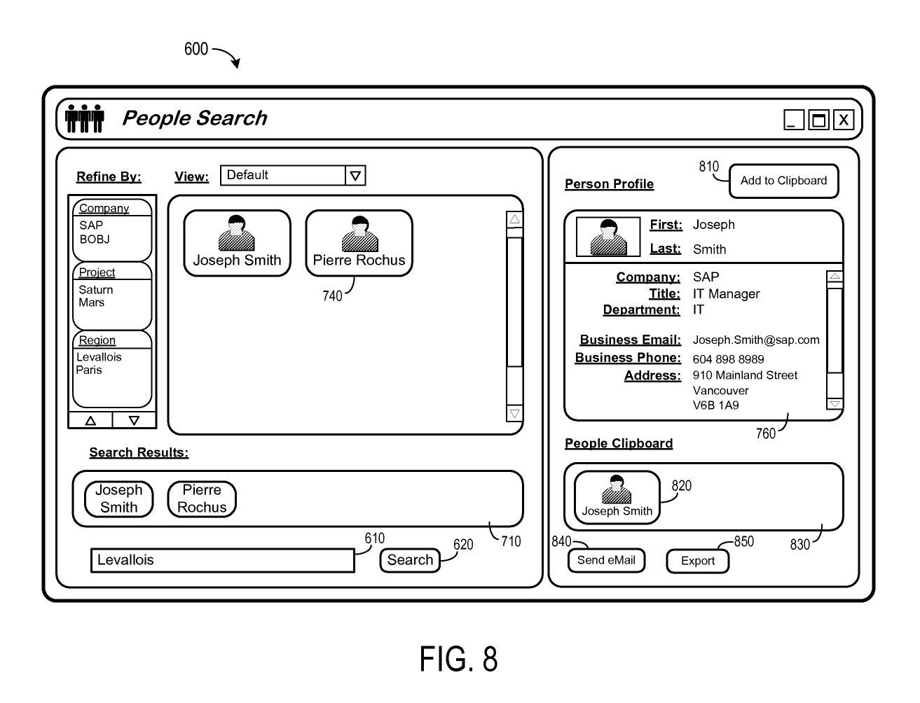

FIG. 8 illustrates a selection of Add to Clipboard button 810. This selection results in display of icon 820 within clipboard window 830. As mentioned above, icon 740 may be selected to cause profile window 760 to display an entity profile of the associated entity. Icon 820 of clipboard window 830 may then be selected to re-display its associated entity profile in profile window 760.

Additionally, selection of Send eMail button 840 may invoke an email form in which the To: field is pre-filled with email addresses of entities displayed in profile window 760, clipboard window 820, or both. Export button 850 may export entity profiles associated with entities displayed in one or both of profile window 760 and clipboard window 820 to a file (e.g., .doc, .xls, .csv). Moreover, other or additional search values may be entered in search box 610 and search button 620 may be selected. This selection may invoke process 500 and cause display of resulting entities in results window 710, and of one or more corresponding entity profiles in profile window 760.

The embodiments described herein are solely for the purpose of illustration. Those in the art will recognize that other embodiments may be practiced with modifications and alterations limited only by the claims.

What is claimed is:

1. A method comprising:
determining a first set of attribute-value pairs associated with an entity, the first set of attribute-value pairs comprising a plurality of attributes and first values, and respective ones of the first values corresponding to each of the plurality of attributes;
determining a second set of attribute-value pairs associated with the entity, the second set of attribute-value pairs comprising the plurality of attributes and second values, and respective ones of the second values corresponding to each of the plurality of attributes; and
generating index entries, each of the index entries indicating one of the first set or the second set of attribute-value pairs, an attribute of the indicated set of attribute-value pairs, a value of the attribute of the indicated set of attribute-value pairs, and the entity.

2. A method according to claim 1, wherein the entity is a person.

3. A method according to claim 1, further comprising:
receiving a search query comprising a search value; and
creating a search expression comprising, for each of the plurality of attributes, the search constraints ((identifier of the first set of attribute-value pairs, attribute), the search value) and ((identifier of the second set of attribute-value pairs, attribute), the search value).

4. A method according to claim 3, further comprising:
applying the search expression against the index entries;
receiving a search result; and
determining an entity profile based on the search result, the entity profile comprising an entity identifier and a plurality of attribute-value pairs associated with the entity identifier.

5. A method according to claim 4, wherein determining the entity profile comprises:
determining an attribute associated with the entity identifier;
determining that a priority of the first set of attribute-value pairs is higher than a priority of the second set of attribute-value pairs for the determined attribute; and
adding an attribute-value pair comprising a first value associated with the determined attribute from the first set of attribute-value pairs to the entity profile and not adding an attribute-value pair comprising a second value associated with the determined attribute from the second set of attribute-value pairs to the entity profile.

6. A method according to claim 5, further comprising:
determining a second attribute associated with the entity identifier;
determining a second two values associated with the determined second attribute, a first one of the second two values associated with the first set of attribute-value pairs, and a second one of the second two values associated with the second set of attribute-value pairs;
determining that the second attribute is a multi-valued attribute; and
adding an attribute-value pair comprising the first one of the second two values, the second one of the second two values and the determined second attribute to the entity profile.

7. A method according to claim 5, further comprising:
determining a second attribute associated with the entity identifier;
determining that the second attribute is a member of an attribute group;
determining that a priority of the first set of attribute-value pairs is higher than a priority of the second set of attribute-value pairs for the determined attribute group;
determining values associated with the second attribute and with each other attribute of the attribute group from the first set of attribute-value pairs; and
adding attribute-value pairs comprising the determined values associated with the second attribute and with each other attribute of the attribute group to the entity profile and not adding attribute-value pairs comprising values associated with the second attribute and with each other attribute of the attribute group from the second set of attribute-value pairs to the entity profile.

8. A method according to claim 3, further comprising:
determining a third set of attribute-value pairs associated with the entity and with a third data source, the third set of attribute-value pairs comprising the plurality of attributes and third values, a respective one of the third values corresponding to each of the plurality of attributes,
wherein creating the search expression comprises:
determining that a user from whom the search value was received is not authorized to search the third set of attribute-value pairs associated with the third data source.

9. A method according to claim 3,
wherein creating the search expression comprises:
determining that a user from whom the search value was received is associated with a search-limiting attribute and a search-limiting value, and
wherein the search expression comprises the search constraint ((identifier of the first set of attribute-value pairs, search-limiting attribute), search-limiting value) and ((identifier of the second set of attribute-value pairs, search-limiting attribute), search-limiting value).

10. A method comprising:
determining a first set of attribute-value pairs associated with an entity, the first set of attribute-value pairs comprising a plurality of attributes and first values, and respective ones of the first values corresponding to each of the plurality of attributes;
determining a second set of attribute-value pairs associated with the entity, the second set of attribute-value pairs comprising the plurality of attributes and second values, and respective ones of the second values corresponding to each of the plurality of attributes;
determining that one of the plurality of attributes is mono-valued;
determining that a priority of the first set of attribute-value pairs is higher than a priority of the second set of attribute-value pairs for the determined attribute; and
adding a first value associated with the determined attribute from the first set of attribute-value pairs to a profile of the entity and not adding a second value associated with the determined attribute from the second set of attribute-value pairs to the profile of the entity.

11. A method according to claim 10, further comprising:
determining a second attribute associated with the entity;
determining a second two values associated with the determined second attribute, a first one of the second two values associated with the first set of attribute-value pairs, and a second one of the second two values associated with the second set of attribute-value pairs;
determining that the second attribute is a multi-valued attribute; and
adding the first one of the second two values and the second one of the second two values to the profile of the entity.

12. A method according to claim 10, further comprising:
determining a second attribute associated with the entity;
determining that the second attribute is a member of an attribute group;
determining that a priority of the first set of attribute-value pairs is higher than a priority of the second set of attribute-value pairs for the determined attribute group;
determining values associated with the second attribute and with each other attribute of the attribute group from the first set of attribute-value pairs; and
adding the determined values associated with the second attribute and with each other attribute of the attribute group to the profile of the entity and not adding values associated with the second attribute and with each other attribute of the attribute group from the second set of attribute-value pairs to the profile of the entity.

13. A method according to claim 12, further comprising:
determining a third attribute associated with the entity;
determining that the third attribute is a member of a second attribute group;
determining that second attribute group is multi-valued;
determining values associated with the third attribute and with each other attribute of the second attribute group from the first set of attribute-value pairs;
determining values associated with the third attribute and with each other attribute of the second attribute group from the second set of attribute-value pairs; and
adding the determined values associated with the third attribute and with each other attribute of the second attribute group to the profile of the entity.

14. A method according to claim 10, further comprising:
receiving a request for the profile of the entity from a user;
determining that the user is not associated with a second data source that is associated with the second set of attribute-value pairs; and
determining to omit the second values corresponding to each of the plurality of attributes from the profile of the entity.

15. A method according to claim 10, further comprising:
receiving a request for the profile of the entity from a user;
determining that the user is not associated with one of the plurality of attributes; and
determining to omit the one of the first values and the one of the second values corresponding to the one of the plurality of attributes from the profile of the entity.

16. A computer-readable medium having stored thereon program code, the program code executable by a computer to:
determine a first set of attribute-value pairs associated with an entity, the first set of attribute-value pairs comprising a plurality of attributes and first values, and respective ones of the first values corresponding to each of the plurality of attributes;
determine a second set of attribute-value pairs associated with the entity, the second set of attribute-value pairs comprising the plurality of attributes and second values, and respective ones of the second values corresponding to each of the plurality of attributes; and
generate index entries, each of the index entries indicating one of the first set or the second set of attribute-value pairs, an attribute of the indicated set of attribute-value pairs, a value of the attribute of the indicated set of attribute-value pairs, and the entity.

17. A medium according to claim 16, wherein the entity is a person.

18. A medium according to claim 16, the program code further executable by a computer to:
receive a search query comprising a search value; and
create a search expression comprising, for each of the plurality of attributes, the search constraints ((identifier of the first set of attribute-value pairs, attribute), the search value) and ((identifier of the second set of attribute-value pairs, attribute), the search value).

19. A medium according to claim 18, the program code further executable by a computer to:
apply the search expression against the index entries;
receive a search result; and
determine an entity profile based on the search result, the entity profile comprising an entity identifier and a plurality of attribute-value pairs associated with the entity identifier.

20. A medium according to claim 19, wherein the program code executable by a computer to determine the entity profile comprises program code executable by a computer to:
determine an attribute associated with the entity identifier;
determine that a priority of the first set of attribute-value pairs is higher than a priority of the second set of attribute-value pairs for the determined attribute; and
add an attribute-value pair comprising a first value associated with the determined attribute from the first set of attribute-value pairs to the entity profile and not adding an attribute-value pair comprising a second value associated with the determined attribute from the second set of attribute-value pairs to the entity profile.

21. A medium according to claim 20, the program code further executable by a computer to:
determine a second attribute associated with the entity identifier;
determine a second two values associated with the determined second attribute, a first one of the second two values associated with the first set of attribute-value pairs, and a second one of the second two values associated with the second set of attribute-value pairs;
determine that the second attribute is a multi-valued attribute; and
add an attribute-value pair comprising the first one of the second two values, the second one of the second two values and the determined second attribute to the entity profile.

22. A medium according to claim 20, the program code further executable by a computer to:
determine a second attribute associated with the entity identifier;
determine that the second attribute is a member of an attribute group;
determine that a priority of the first set of attribute-value pairs is higher than a priority of the second set of attribute-value pairs for the determined attribute group;
determine values associated with the second attribute and with each other attribute of the attribute group from the first set of attribute-value pairs; and
add attribute-value pairs comprising the determined values associated with the second attribute and with each other attribute of the attribute group to the entity profile and not adding attribute-value pairs comprising values associated with the second attribute and with each other attribute of the attribute group from the second set of attribute-value pairs to the entity profile.

23. A medium according to claim 18, the program code further executable by a computer to:
determine a third set of attribute-value pairs associated with the entity and with a third data source, the third set of attribute-value pairs comprising the plurality of attributes and third values, a respective one of the third values corresponding to each of the plurality of attributes,
wherein the program code executable by a computer to create the search expression comprises program code executable by a computer to:
determine that a user from whom the search value was received is not authorized to search the third set of attribute-value pairs associated with the third data source.

24. A medium according to claim 18,
wherein the program code executable by a computer to create the search expression comprises program code executable by a computer to:
determine that a user from whom the search value was received is associated with a search-limiting attribute and a search-limiting value, and
wherein the search expression comprises the search constraint ((identifier of the first set of attribute-value pairs, search-limiting attribute), search-limiting value) and ((identifier of the second set of attribute-value pairs, search-limiting attribute), search-limiting value).

25. A computer-readable medium having stored thereon program code, the program code executable by a computer to:
determine a first set of attribute-value pairs associated with an entity, the first set of attribute-value pairs comprising a plurality of attributes and first values, and respective ones of the first values corresponding to each of the plurality of attributes;
determine a second set of attribute-value pairs associated with the entity, the second set of attribute-value pairs comprising the plurality of attributes and second values, and respective ones of the second values corresponding to each of the plurality of attributes;
determine that one of the plurality of attributes is mono-valued;
determine that a priority of the first set of attribute-value pairs is higher than a priority of the second set of attribute-value pairs for the determined attribute; and
add a first value associated with the determined attribute from the first set of attribute-value pairs to a profile of the entity and not adding a second value associated with the determined attribute from the second set of attribute-value pairs to the profile of the entity.

26. A medium according to claim 25, the program code further executable by a computer to:
determine a second attribute associated with the entity;
determine a second two values associated with the determined second attribute, a first one of the second two values associated with the first set of attribute-value pairs, and a second one of the second two values associated with the second set of attribute-value pairs;
determine that the second attribute is a multi-valued attribute; and
add the first one of the second two values and the second one of the second two values to the profile of the entity.

27. A medium according to claim 25, the program code further executable by a computer to:
determine a second attribute associated with the entity;
determine that the second attribute is a member of an attribute group;
determine that a priority of the first set of attribute-value pairs is higher than a priority of the second set of attribute-value pairs for the determined attribute group;
determine values associated with the second attribute and with each other attribute of the attribute group from the first set of attribute-value pairs; and
add the determined values associated with the second attribute and with each other attribute of the attribute group to the profile of the entity and not adding values associated with the second attribute and with each other attribute of the attribute group from the second set of attribute-value pairs to the profile of the entity.

28. A medium according to claim 27, the program code further executable by a computer to:
determine a third attribute associated with the entity;
determine that the third attribute is a member of a second attribute group;
determine that second attribute group is multi-valued;
determine values associated with the third attribute and with each other attribute of the second attribute group from the first set of attribute-value pairs;
determine values associated with the third attribute and with each other attribute of the second attribute group from the second set of attribute-value pairs; and
add the determined values associated with the third attribute and with each other attribute of the second attribute group to the profile of the entity.

29. A medium according to claim 25, the program code further executable by a computer to:
receive a request for the profile of the entity from a user;
determine that the user is not associated with a second data source that is associated with the second set of attribute-value pairs; and
determine to omit the second values corresponding to each of the plurality of attributes from the profile of the entity.

30. A medium according to claim 25, the program code further executable by a computer to:
receive a request for the profile of the entity from a user;
determine that the user is not associated with one of the plurality of attributes; and
determine to omit the one of the first values and the one of the second values corresponding to the one of the plurality of attributes from the profile of the entity.
